(19) United States
(12) Patent Application Publication
(10) Pub. No.: US 2016/0347425 A1
(43) Pub. Date: Dec. 1, 2016

(54) MARINE MOBILE NETWORK DEVICE AND MARINE SELF-POWERED GENERATING SYSTEM THEREOF

(71) Applicant: HSIN-CHI SU, TAIPEI CITY (TW)

(72) Inventor: HSIN-CHI SU, TAIPEI CITY (TW)

(21) Appl. No.: 15/165,946

(22) Filed: May 26, 2016

(30) Foreign Application Priority Data
May 27, 2015 (TW) 104116963

(51) Int. Cl. B63B 35/44; H02S 40/38; G05D 1/00; H02S 10/40; H04W 4/02; B63H 21/17

(52) U.S. Cl. CPC B63B 35/44; H04W 4/02; B63H 21/17; G05D 1/0027; H02S 10/40; H02S 40/38; B63B 2035/4453; B63B 2035/008

(57) ABSTRACT

A marine mobile network device and a marine self-powered generating system thereof are provided. The marine mobile network device includes a transparent body, a pumping unit, a power storage module, a driving module, an antenna module and a processing module. The transparent body is disposed with three accommodating spaces, and the pumping unit adjusts the fluids in the accommodating space to change a center of gravity of the transparent body, such that the transparent body can lie on or stand on the sea. The power storage module is capable of storing and supplying the power. The driving module drives the transparent body to move. The antenna module is disposed to receive a movement signal or a transferred signal transmitted from a remote end. The processing unit controls the driving unit to actuate according to the movement signal, or controls the pumping unit to actuate according to the transferred signal.

### CROSS-REFERENCE TO RELATED APPLICATION

This application claims the benefit of Taiwan Patent Application No. 104116963, filed on May 27, 2015, in the Taiwan Intellectual Property Office, the disclosure of which is incorporated herein in its entirety by reference.

### BACKGROUND OF THE INVENTION

1. Field of the Invention

The present disclosure generally relates to a mobile network device, in particular to a marine mobile network device and a marine self-powered generating system thereof.

2. Description of the Related Art

Regarding the conventional maritime mobile devices, most of them can merely move and are not able to change the marine positions. Hence, the applied scope of the conventional maritime mobile devices is not wide. For example, when the maritime mobile device is provided with a solar panel, because it cannot provide the function of changing marine position states, the angle which the solar panel receives sunlight is limited, thereby affecting the efficiency of power generation.

As a result, when a maritime mobile device is applied as a detector to detect the environment parameters, or as a communication device for information transmission, the condition of self-sufficiency cannot be satisfied. Furthermore, one or more maritime mobile devices cannot be applied to build a maritime self-powered generating system.

As a result, the inventor of the disclosure has been mulling over the technical problems and then designs a marine mobile device and a marine power generating system thereof which aims to improve the current technical shortcomings so as to promote the industrial practicability.

### SUMMARY OF THE INVENTION

The primary object of the present disclosure is to provide a marine mobile network device and a marine self-powered generating system thereof which aims to resolve the technical problems of the prior art.

To achieve the foregoing objective, the present disclosure provides a marine mobile network device which may include a transparent body, a pumping unit, a power storage module, a driving module, an antenna module and a processing module. A transverse section of the main accommodating space may be a regular polygonal structure or a star structure and may have a plurality of planes. The plurality of sub-accommodating spaces may be disposed oppositely in pairs on the transparent body, wherein two sub-accommodating spaces which are opposite to each other are adjacent to one end of the transparent body and the other two sub-accommodating spaces which are opposite to each other are adjacent to the other end of the transparent body. The pumping unit may be connected to a fluid channel; the fluid channel may be connected to each of the plurality of sub-accommodating spaces, and the pumping unit may facilitate fluids flowing to the other two sub-accommodating spaces which are opposite to each other or to the plurality of sub-accommodating spaces which are at the same side of the transparent body. The power storage module may be disposed to store and supply electricity. The driving module may be disposed at the other end of the transparent body and to drive the transparent body to move. The antenna module may be disposed on the transparent body and may receive a movement signal or a transferred signal transmitted from a remote end. The processing module may be disposed to electrically connect to the antenna module and may control the driving module to operate according to the movement signal or may control the pumping unit to operate according to the transferred signal.

Preferably, the marine mobile network device may further include a plurality of solar panels electrically connected to the power storage module and respectively disposed on each of the planes, so as to receive light to generate electricity and store the electricity in the power storage module.

Preferably, the transparent body may be made of fiberglass reinforced plastic (FRP) or similar materials.

Preferably, the marine mobile network device may further include a positioning module disposed to generate a position signal according to a current position of the transparent body, and the position signal may be transmitted to a remote end by the antenna module.

Preferably, the remote end may transmit the transferred signal to the marine mobile network device according to the position signal.

Preferably, the marine mobile network device may further include at least one guide vane disposed at one side of the transparent body.

Preferably, the driving module may include a driving unit, two connecting rods and a propeller. The two connecting rods may be pivotally connected with each other, the driving unit may be connected to one end of one of the connecting rods, and the propeller may be connected to one end of the other connecting rod.

Preferably, when fluids flow to the plurality of sub-accommodating spaces which are at the same side of the transparent body, the transparent body may lie on the sea, and when fluids flow to the other two sub-accommodating spaces which are opposite to each other, the transparent body may stand on the sea from lying on the sea gradually.

Preferably, an amount of fluids flowing to the other two sub-accommodating spaces which are opposite to each other may be adjusted to change a center of gravity of the transparent body so as to adjust an angle of the transparent body standing on the sea.

Preferably, fluids may be adjusted to flow to the same side or the other side of the transparent body, such that the transparent body has a rotational movement.

Preferably, the transverse section of the main accommodating space may be a regular polygonal structure of a pentagonal, a hexagonal, a heptagonal or an octagonal structure.

Preferably, the marine mobile network device may further include a temperature detection module, an air flow driving module and a gas channel. The air flow driving module may be connected to the gas channel. One end of the gas channel may be disposed at the other side of the transparent body, and the other end of the gas channel may be connected to the other end of the transparent body. The air flow driving module may be disposed to inhale gas by one end of the gas channel and to exhale gas by the other end of the gas channel. The temperature detection module may be disposed in the transparent body to detect a temperature of the transparent body, and when a temperature of the transparent body exceeds in a predetermined temperature, the air flow driving module may be driven to operate by the temperature detection module.

In order to achieve the aforementioned objective, the present disclosure further provides a marine self-powered generating system which may include a plurality of marine mobile network devices. Each of the marine mobile network devices may include a transparent body which is a hollow columnar structure and may include a main accommodating space of which a transverse section is a regular polygonal structure or a star structure and having a plurality of planes; a plurality of sub-accommodating spaces disposed oppositely in pairs on the transparent body, wherein two sub-accommodating spaces which are opposite to each other are adjacent to one end of the transparent body and the other two sub-accommodating spaces which are opposite to each other are adjacent to the other end of the transparent body; a pumping unit connected to a fluid channel; the fluid channel connected to each of the plurality of sub-accommodating spaces, and the pumping unit facilitating fluids flowing to the other two sub-accommodating spaces which are opposite to each other or to the plurality of sub-accommodating spaces which are at the same side of the transparent body; a power storage module disposed to store and supply electricity; a driving module disposed at the other end of the transparent body and to drive the transparent body to move; an antenna module disposed on the transparent body and to receive a movement signal or a transferred signal transmitted from a remote end; a processing module disposed to electrically connect to the antenna module and controlling the driving module to operate according to the movement signal or controlling the pumping unit to operate according to the transferred signal; and a plurality of solar panels electrically connected to the power storage module and respectively disposed on each of the planes, so as to receive light to generate electricity and store the electricity in the power storage module. The marine self-powered generating system may also include an electricity collection plant which may be on a land adjacent to a marine position for power transmission, and the marine mobile network device may move from the marine position for power generation to the marine position for power transmission so as to transmit the power of the power storage module to the electricity collection plant.

Preferably, the transparent body may be made of fiberglass reinforced plastic (FRP) or similar materials.

Preferably, the marine self-powered generating system may further include a positioning module disposed to produce a position signal according to a current position of the transparent body, and the position signal may be transmitted to a remote end by the antenna module. The remote end may transmit the transferred signal to the marine mobile network device according to the position signal.

Preferably, the marine self-powered generating system may further include at least one guide vane disposed at one side of the transparent body.

Preferably, the driving module may include a driving unit, two connecting rods and a propeller. The two connecting rods may be pivotally connected with each other, the driving unit may be connected to one end of one of the connecting rods, and the propeller may be connected to one end of the other connecting rod.

Preferably, when fluids flow to the plurality of sub-accommodating spaces which are at the same side of the transparent body, the transparent body may lie on the sea, and when fluids flow to the other two sub-accommodating spaces which are opposite to each other, the transparent body may stand on the sea from lying on the sea gradually.

Preferably, an amount of fluids flowing to the other pair of sub-accommodating spaces which is opposite to one side of the transparent body may be adjusted to change a center of gravity of the transparent body so as to adjust an angle of the transparent body standing on the sea with an angle from 30° to 60°.

Preferably, fluids may be adjusted to flow to the same side or the other same side of the transparent body, such that the transparent body has a rotational movement.

Preferably, the transverse section of the main accommodating space may be a regular polygonal structure of a pentagonal, a hexagonal, a heptagonal or an octagonal structure.

Preferably, the marine self-powered generating system may further include a temperature detection module, an air flow driving module and a gas channel. The air flow driving module may be connected to the gas channel, one end of the gas channel may be disposed at the other side of the transparent body and the other end of the gas channel may be connected to the other end of the transparent body. The air flow driving module may be disposed to inhale gas by one end of the gas channel and to exhale gas by the other end of the gas channel. The temperature detection module may be disposed in the transparent body to detect a temperature of the transparent body, and when a temperature of the transparent body exceeds in a predetermined temperature, the air flow driving module may be driven to operate by the temperature detection module.

As mentioned previously, a marine mobile network device and a marine self-powered generating system thereof of the present disclosure may have one or more advantages as follows.

1. By means of the disposition of sub-accommodating spaces, a marine mobile network device of the present disclosure enable to adjust the center of gravity thereof by the pumping module to hereby transfer the state of the marine mobile network device on the sea.

2. By changing the angle of standing on the sea, a marine mobile network device of the present disclosure enable to hereby effectively promote the solar power generation.

3. Forming a marine power plant by means of a plurality of marine mobile network devices, a marine mobile network device and a marine self-powered generating system thereof of the present disclosure enable to hereby promote the applied field.

4. By means of the predetermined structure of the driving module, a marine mobile network device of the present disclosure enable to move the marine mobile network device whether the marine mobile network device lies or stands on the sea.

### BRIEF DESCRIPTION OF THE DRAWINGS

The detailed structure, operating principle and effects of the present disclosure will now be described in more details hereinafter with reference to the accompanying drawings that show various embodiments of the disclosure as follows.

FIG. 1 is structural schematic of an embodiment of a marine mobile network device of the present disclosure.

FIG. 2 is a block diagram showing the embodiment of a marine mobile network device of the present disclosure.

FIG. 3 is a schematic diagram showing different states of the embodiment of a marine mobile network device of the present disclosure.

FIG. 4 is a cross-sectional view showing a main accommodating space of the embodiment of a marine mobile network device of the present disclosure.

FIG. 5 is a schematic diagram showing the embodiment of a marine mobile network device of the present disclosure receiving solar power.

FIG. 6 is a schematic diagram showing the first rotation transformation of the embodiment of a marine mobile network device of the present disclosure.

FIG. 7 is a schematic diagram showing the second rotation transformation of the embodiment of a marine mobile network device of the present disclosure.

FIG. 8 is a schematic diagram showing the embodiment of a marine mobile network device of the present disclosure standing on the sea.

FIG. 9 is a schematic diagram showing a marine mobile network device of the present disclosure diving in the sea.

FIG. 10 is a schematic diagram showing the embodiment of a guide vane of a marine mobile network device of the present disclosure.

FIG. 11 is a schematic diagram showing the embodiment of a marine mobile network device of the present disclosure guiding flows.

FIG. 12 is a schematic diagram showing the deposition of a marine self-powered generating system of the present disclosure.

### DETAILED DESCRIPTION OF THE PREFERRED EMBODIMENTS

Hereinafter, embodiments of the present disclosure will be described in detail with reference to the accompanying drawings so that those skilled in the art to which the present disclosure pertains can realize the present disclosure. As those skilled in the art would realize, the described embodiments may be modified in various different ways, all without departing from the spirit or scope of the present disclosure.

The drawings and description are to be regarded as illustrative in nature and not restrictive. Similar reference numerals designate similar elements throughout the specification.

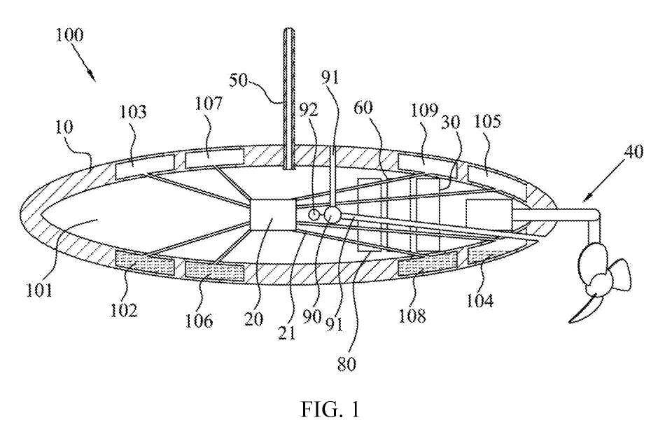

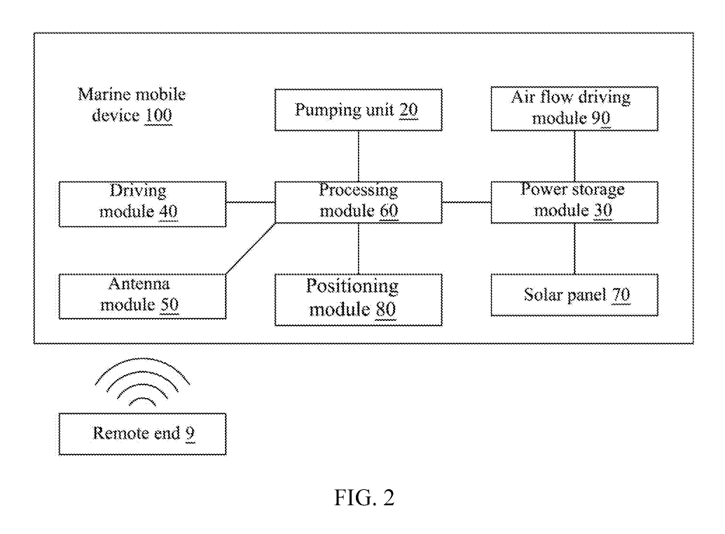

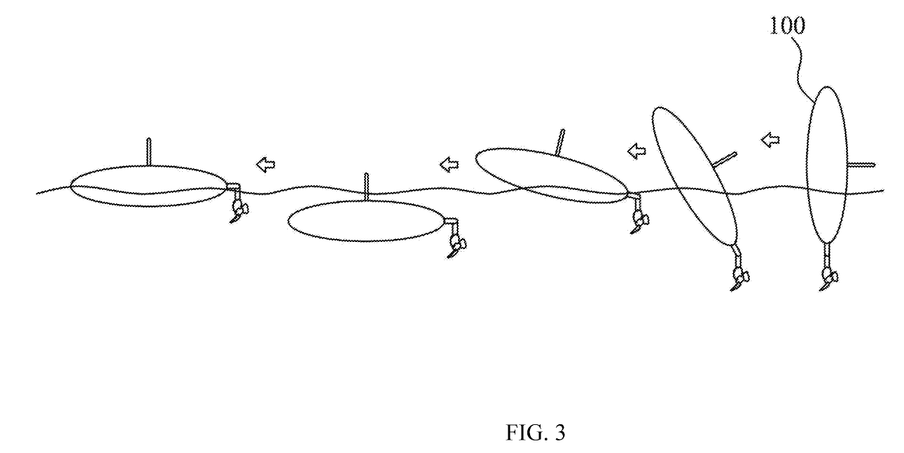

Please refer to FIG. 1 to FIG. 3, which are a structural schematic diagram, a block diagram and a schematic diagram showing different states of the embodiment of a marine mobile network device of the present disclosure, respectively. The marine mobile network device of the present disclosure is feasible to be applied to the applications such as solar power generation, environmental parameter detection, and data transmission . . . etc. on the sea. As shown in the figures, a marine mobile network device 100 includes a transparent body 10, a pumping unit 20, a power storage module 30, a driving module 40, an antenna module 50 and a processing module 60. The transparent module 10 is a hollow columnar structure. Preferably, the transparent body 10 is made of fiberglass reinforced plastic (FRP) or similar materials to hereby provide functions for receiving luminous energy suitably, as well as waterproof and alkali resistance. The transparent body 10 includes a main accommodating space 101 and a plurality of sub-accommodating spaces. Here, an amount of the sub-accommodating spaces is preferably 4, 6 or 8. In the embodiment, 8 sub-accommodating spaces are served as the exemplary aspect. The transparent body 10 includes a first sub-accommodating space 102, a second sub-accommodating space 103, a third sub-accommodating space 104, a fourth sub-accommodating space 105, a fifth sub-accommodating space 106, a sixth sub-accommodating space 107 and a seventh sub-accommodating space 108 and a eighth sub-accommodating space 109. The transverse section of the main accommodating space 101 is a regular polygonal structure or a star structure and has a plurality of planes. The first sub-accommodating space 102 and the second sub-accommodating space 103 are opposite to each other and disposed in the transparent body 10 adjacent one end of the transparent body 10. The third sub-accommodating space 104 and the fourth sub-accommodating space 105 are opposite to each other and disposed in the transparent body 10 adjacent to the other end of the transparent body 10. The fourth sub-accommodating space 105 and the fifth sub-accommodating space 106 are opposite to each other in the transparent body 10 and between both ends of the transparent body 10 and adjacent to the first sub-accommodating space 102 and the second sub-accommodating space 103. The seventh sub-accommodating space 108 and the eighth sub-accommodating space 109 are opposite to each other in the transparent body 10 and between both ends of the transparent body 10 and adjacent to the third sub-accommodating space 104 and the fourth sub-accommodating space 105.

The pumping unit 20 is connected to a fluid channel 21, and the flow channel 21 is connected to each of the plurality of sub-accommodating spaces. The pumping unit 20 may be a pump which is provided to facilitate the fluids such as water, sea water or pure water to flow to the third sub-accommodating space 104 and the fourth sub-accommodating space 105, and even to the third sub-accommodating space 104, the fourth sub-accommodating space 105, the seventh sub-accommodating space 108 and the eighth sub-accommodating space 109. Alternatively, the pumping unit 20 is provided to facilitate fluids to flow to the first sub-accommodating space 102, the third sub-accommodating space 104, the fifth sub-accommodating space 106 and the seventh sub-accommodating space 108. That is to say, the pumping unit 20 is provided to facilitate fluids to flow to the sub-accommodating space which is at other end of the transparent body 10 or to the sub-accommodating space which is at the same side of the transparent body 10.

The power storage module 30 is provided to store and supply electricity. The driving module 40 is disposed at the other end of the transparent body 10 and to drive the transparent body 10 to move. The antenna module 50 is disposed on the transparent body 10 and to receive a movement signal or a transferred signal transmitted from a remote end 9. The antenna module 50 is disposed with a ventilation channel to enable air flowing therethrough. The processing module 60, which may be components such as processor, microprocessor, and so on, is disposed to electrically connect to the pumping unit 20, the driving module 40 and the antenna module 50 to control the driving module 40 to operate according to the movement signal or to control the pumping unit 20 to operate according to the transferred signal. It is worth mentioning that the antenna module 50 may be achieved according to the “ANTENNA STABILIZING APPARATUS” disclosed in U.S. Pat. No. 8,004,472.

To be precise, when the first sub-accommodating space 102, the third sub-accommodating space 104, the fifth sub-accommodating space 106 and the seventh sub-accommodating space 108 accommodate fluids, the transparent body 10 can lie on the sea because of the center of gravity. Besides, the driving module 40 enables the transparent body 40 moving on the sea with a laying position and detecting the environmental parameter or transmitting data through the marine mobile network device 100. When the pumping unit 20 enables the fluids gradually flowing from the first sub-accommodating space 102 and the fifth sub-accommodating space 106 to the fourth sub-accommodating space 105 and the seventh sub-accommodating space 108, the transparent body 10 stands on the sea from lying on the sea because the center of gravity changes. Under the circumstances, the marine mobile network device 100 is capable of generating the solar power, detecting the environmental parameter and transmitting data, and so on. To the contrary, if changing the transparent body 10 into a laying position is necessary, the pumping unit 20 enables the fluids gradually flowing from the fourth sub-accommodating space 105 and the eighth sub-accommodating space 109 to the first sub-accommodating space 102 and the fifth sub-accommodating space 106.

It is noteworthy that the marine mobile network device 100 further includes an air flow driving module 90 and a gas channel 91. The air flow driving module 90 may be a pump and is disposed in the transparent body 10 and connected to the gas channel 91. One end of the gas channel 91 is disposed at one side of the transparent body 10 (i.e. at the same side of the antenna module 50) and the other end of the gas channel 91 is connected to the other end of the transparent body 10. An exit of the other end of the gas channel 91 is arranged downwards. According to the control of the processing module 60, the air flow driving module 90 is disposed to inhale gas by one end of the gas channel 91 and to exhale gas by the other end of the gas channel 91. As a result, when the transparent body 10 is in a lying state, the air flow driving module 90 and the gas channel 91 are applied to move the marine mobile network device 100 without using the driving module 40. In another applied aspect, one end of the gas channel 91 is disposed in the antenna module 50, that is, one end of the gas channel 91 and the antenna module 50 are arranged together, such that the exit of one end of the gas channel 91 inhales gas at the end of the antenna module 50. Hence, the present disclosure is not limited thereto.

In addition, the marine mobile network device 100 further includes a temperature detection module 92. The temperature detection module 92 is disposed in the transparent body 10 to detect a temperature of the transparent body 10. When the temperature of the transparent body 10 exceeds in a predetermined temperature, the air flow driving module 90 is driven to operate by the temperature detection module. That is to say, the temperature detection module 92 is also configured to control the operation of the air flow driving module 90 so as to cool down the temperature of the transparent body 10, so that the temperature of the transparent body 10 can be maintained stably to prevent the elements disposed in the transparent body 10 from failure resulted from overtemperature.

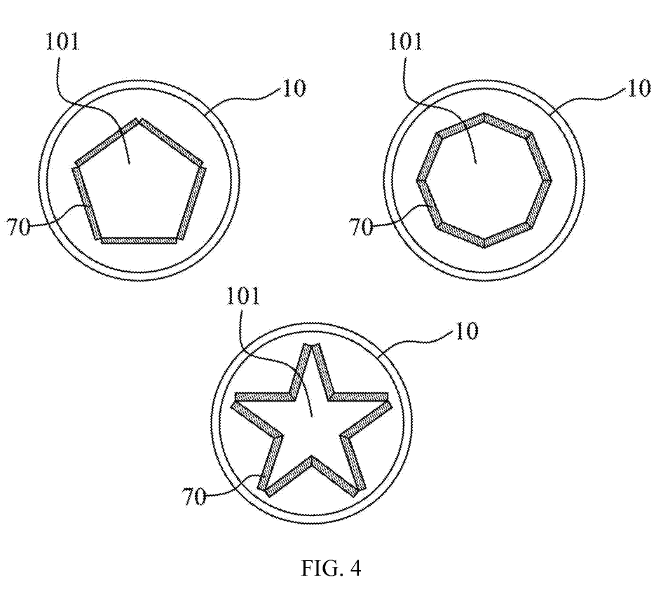

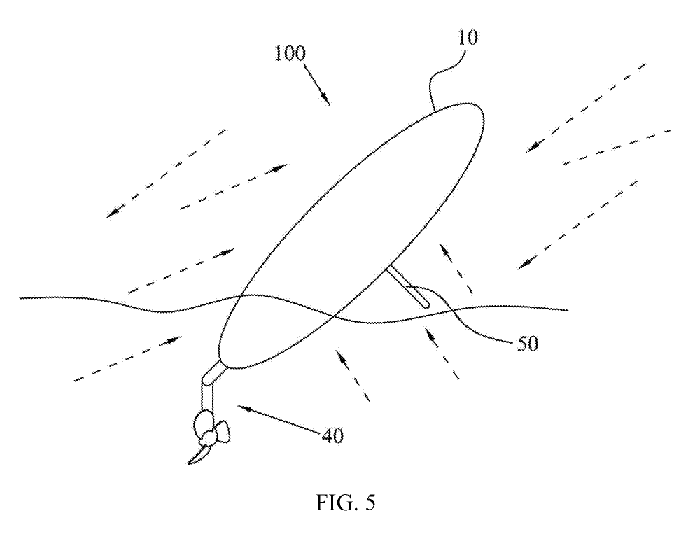

Please refer to FIG. 4 and FIG. 5 together. FIG. 4 is a cross-sectional view showing a main accommodating space of the embodiment of a marine mobile network device of the present disclosure, and FIG. 5 is a schematic diagram showing the embodiment of a marine mobile network device of the present disclosure receiving solar power. Preferably, the transverse section of the main accommodating space 101 is a regular polygonal structure or a star structure, such as a pentagonal, a hexagonal, a heptagonal or an octagonal structure. Here, a pentagonal structure, an octagonal structure and a star structure are applied as the exemplary aspects, but it shall not be limited thereto. A plurality of solar panels 70 are disposed inside the main accommodating space 101 and the plurality of solar panels 70 are connected to the power storage module 30 to receive light to generate electricity and store the generated electricity in the power storage module 30. The plurality of solar panels 70 are respectively disposed on each plane of the main accommodating space 101, such that the sunlight is received adequately to generate the electricity.

It is worth mentioning that the processing module 60 is capable of controlling the pumping module 20 to adjust the fluids accommodated in each of the sub-accommodating spaces, so that the center of gravity of the transparent body 10 is changed to hereby adjust the angle of the transparent body 10 standing on the sea. For example: 30 degrees to 60 degrees (an included angle between the transparent body 10 and the sea level), and preferably, 45 degrees. In this case, the solar panels 70 are capable of receiving the solar light adequately. In addition, by means of the reflection of the sea level, the sunlight is efficiently absorbed so as to effectively generate the electricity for being used or stored.

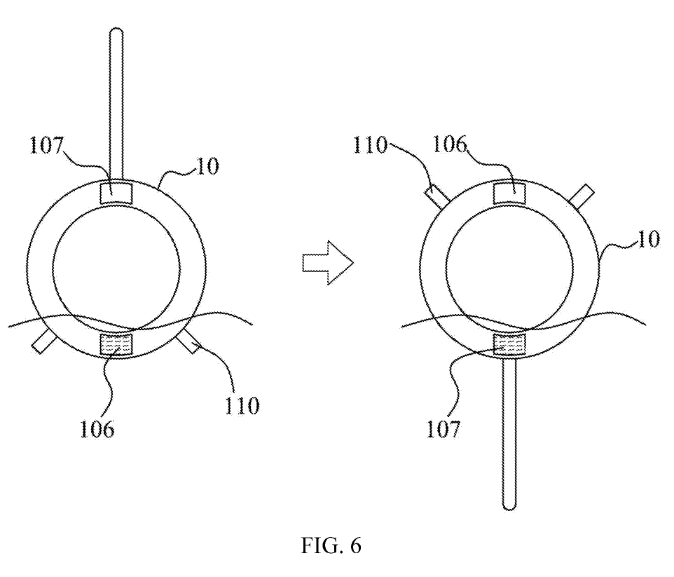

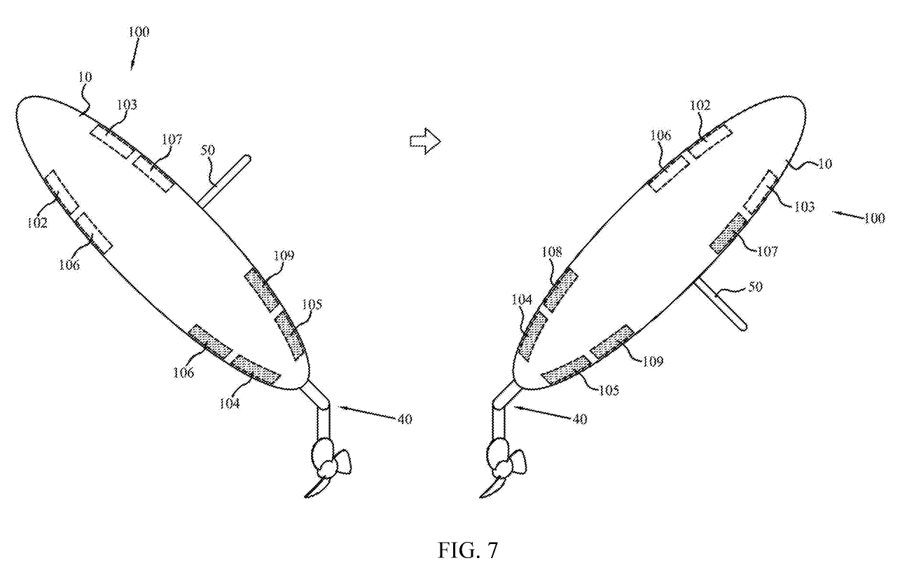

Besides, the processing module 60 also controls the pumping unit 20 to deliver the fluids to one of the second sub-accommodating space 103, the fourth sub-accommodating space 105, the sixth sub-accommodating space 107 and the eighth sub-accommodating space 109 or a combination thereof. According to the arrangement of the center of gravity, the transparent body 10 has the rotational movement in a lying state or a standing state so as to further receive the sunlight, and the temperature of the transparent body 10 can be reduced by the sea water. Please refer to FIG. 6 and FIG. 7 together. When the transparent body 10 is in the lying state and the antenna module 50 faces towards the sky, the first sub-accommodating space 102, the third sub-accommodating space 104, the fifth sub-accommodating space 106 and the seventh sub-accommodating space 108 accommodate with fluids. The pumping unit 20 enables the fluids flowing from the first sub-accommodating space 102, the third sub-accommodating space 104, the fifth sub-accommodating space 106 and the seventh sub-accommodating space 108 to the second sub-accommodating space 103, the fourth sub-accommodating space 105, the sixth sub-accommodating space 107 and the eighth sub-accommodating space 109, such that the center of gravity of the transparent body 10 changes and then the transparent body 10 rotates so as to change the antenna module 50 to face the sea level. As shown in FIG. 6, when the transparent body 10 is in the standing state and the antenna module 50 faces towards the sky, the third sub-accommodating space 104, the fourth sub-accommodating space 105, the seventh sub-accommodating space 108 and the eighth sub-accommodating space 109 accommodate fluids, and the pumping module 20 delivers fluids to one of the second sub-accommodating space 103 and the sixth sub-accommodating space 107 or a combination thereof, such that the center of gravity of the transparent body 10 changes, and then the transparent body 10 rotates to change the antenna module 50 to face the sea level, as shown in FIG. 7.

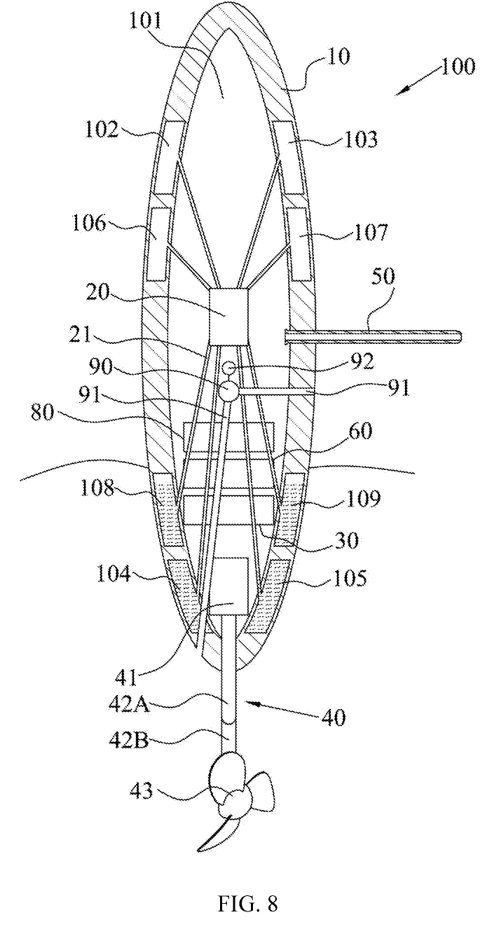

Please refer to FIG. 1 and FIG. 8 together, wherein FIG. 8 is a schematic diagram showing the embodiment of a marine mobile network device of the present disclosure standing on the sea. The driving module 40 includes a driving unit 41, two connecting rods 42A, 42B and a propeller 43. The two connecting rods 42 are pivotally connected with each other, the driving unit 41 is inside the main accommodating space 101 and connected to one end of the connecting rod 42A. The other end of the connecting rod 42A is exposed outside the transparent body 10 and connected to one end of the other connecting rod 42B. The propeller 43 is connected to the other end of the other connecting rod 42B. When the transparent body 10 is lying on the sea, the two connecting rods 42 are pivotally connected with each other, and thus, one connecting rod of the connecting rod 42B moves downwards because of the gravity, such that the propeller 43 rotates to cause stream to move the transparent body 10. When the transparent body 10 is standing on the sea, the two connecting rods 42 are pivotally connected with each other, and thus, the other connecting rod of the connecting rod 42B moves downwards because of the gravity, such that the propeller 43 is below the sea level. Under the circumstances, the propeller 43 still rotates to cause stream to move the transparent body 10.

Furthermore, in another exemplary aspect of the driving module 40, one end of the connecting rod 42 is directly fixed to the transparent body 10 and the other end of the connecting rod 42A is pivotally connected to one end of the connecting rod 42B. The propeller 43 is connected to the other end of the connecting rod 42B. The driving unit 41 is disposed inside the other end of the connecting rod 42B so as to connect to the propeller 43. The processing module 60 and the power storage module 30 are disposed to penetrate though the signal lines installed inside the two connecting rods 42A, 42B to control the driving unit 41 and supply the electricity to the driving unit 41. Here, the driving unit 41 may be a motor module including a speed exchanger, and the propeller 43 may be fans.

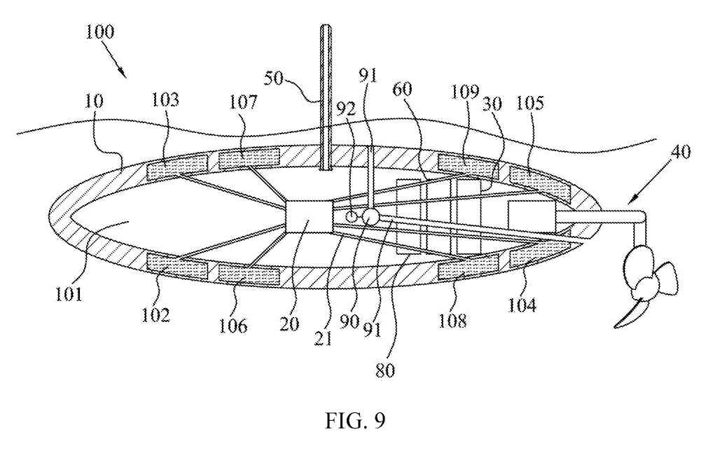

Please refer to FIG. 9, which is a schematic diagram showing a marine mobile network device of the present disclosure diving in the sea. As shown in the figure, the sub-accommodating spaces of the transparent body 10 and the external wall surface of the transparent body 10 may be disposed with valve unit. The pumping unit 20 applies the valve unit to inhale the external fluids, such as sea water or exhales the internal fluids, so as to thereby adjust the transparent body 10 to float on or dive in the sea. Consequently, the marine mobile network device 100 is controlled to dive in the sea to move at an adequate movement. In addition, the sub-accommodating spaces of the transparent body 10 and the external wall surface of the transparent body 10 may also be disposed with an inhaling unit and exhaling unit, such that the external fluids are inhaled by the inhaling unit or the internal fluids are exhaled by the exhaling unit according to the control of the processing module 60.

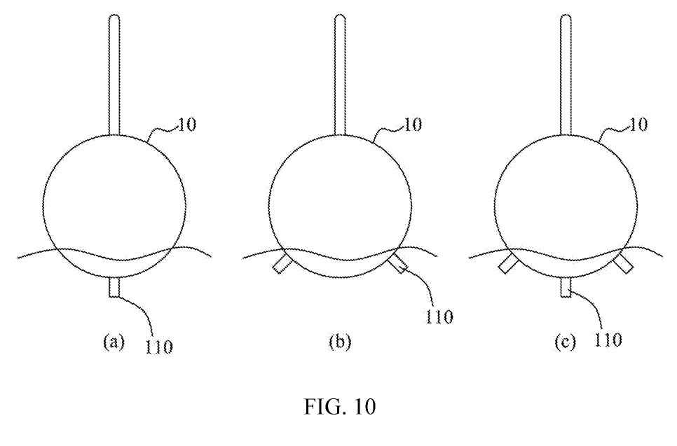

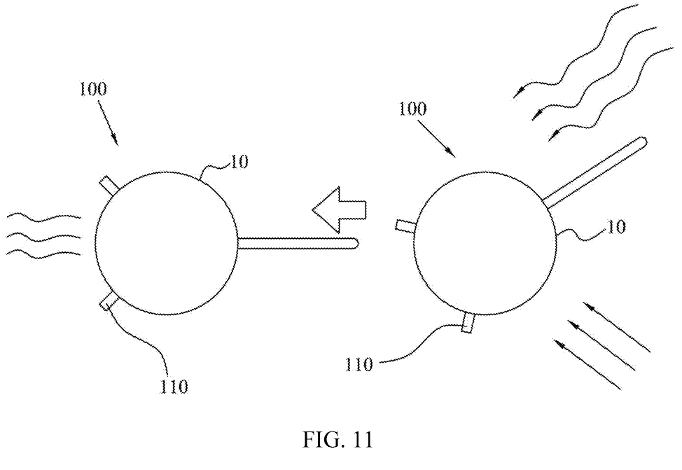

Please refer to FIG. 10 and FIG. 11, which are a schematic diagram showing the embodiment of a guide vane of a marine mobile network device of the present disclosure and a schematic diagram showing the embodiment of a marine mobile network device of the present disclosure guiding flows, respectively. Here, the transparent body 10 includes at least one guide vane 110 disposed at one side of the transparent body 10. An amount of the guide vane 110 may be one, two or three, and the arrangement thereof is shown in FIG. 10. Briefly, the guide vane 110 is disposed at one side of the transparent body 10 and is at the same side as the first sub-accommodating space 102. In the present embodiment, the amount of the guide vane 110 is disposed with two for being served as an exemplary aspect, but it shall be not limited thereto. When the transparent body 10 is disposed with a pair of guide vanes 110, the two guide vanes are disposed oppositely to each other and at one side of the transparent body 10. Namely, the guide vane 110 and the first sub-accommodating space 102 are at the same side of the transparent body 10. As shown in FIG. 11, the guide vane 110 facilitates the transparent body 10 moving on the sea adequately. And when the transparent body 10 is standing on the sea, the guide vane 110 enables to the transparent body 10 moving according to the sea flow (the curved arrowheads shown in the figure) or the wind flow (the straight arrowheads shown in the figure), such that the transparent body 10 is fixed in the same position.

In the other hand, the marine mobile network device 100 includes a positioning module 80 such as GPS. The positioning module 80 is provided to generate a position signal according to the current position of the transparent body 10, and the generated position signal is transmitted to the remote end 9 by the antenna module 50. That is to say, the remote end 9 obtains the position of the marine mobile network device according to the position signal, and the processing module 60 controls the driving module 40 according to the signal to enable the marine mobile network device 100 moving to a predetermined position. When the marine mobile network device 100 arrives at the predetermined position, the remote end 9 transmits a transferred signal to enable the processing module 60 controlling the pumping unit 20 to move the fluids from the first sub-accommodating space 102 and the fifth sub-accommodating space 106 to the fourth sub-accommodating space 105 and the eighth sub-accommodating space 109, such that the transparent body 10 stands on the sea.

It is noteworthy mentioning that in a better automatic control procedure, the processing module 60 also automatically controls the driving module 40 according to the position signal to enable the marine mobile network device 100 moving to the predetermined position. When the marine mobile network device 100 arrived at the predetermined position, the processing module 60 automatically controls the pumping unit 20 to move the fluids from the first sub-accommodating space 102 and the fifth sub-accommodating space 106 to the fourth sub-accommodating space 105 and the eighth sub-accommodating space 109, such that the transparent body 10 stands on the sea.

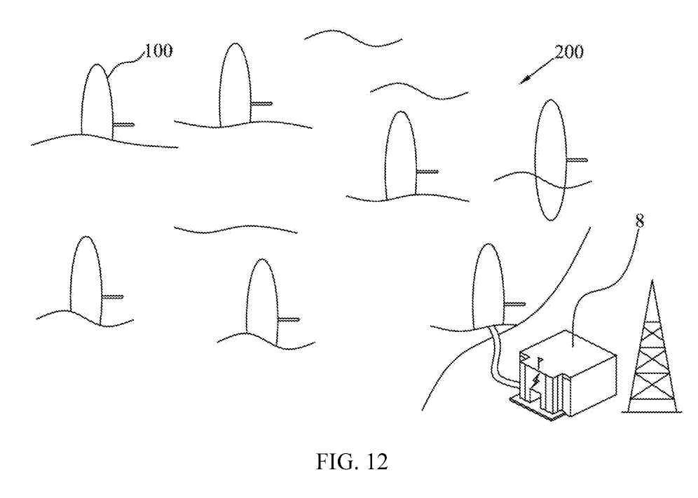

Please refer to FIG. 12, which is a schematic diagram showing the deposition of a marine self-powered generating system of the present disclosure. In the figure, the aforementioned marine mobile network device 100 is applied to a marine self-powered generating system 200 as an exemplary aspect, but it shall be not limited thereto.

The marine self-powered generating system 200 is formed according to a plurality of aforementioned marine mobile network devices 100 and an electricity collection plant 8. The marine mobile network device 100 moves to a marine position for power generation and transfers to the state of standing on the sea. Here, the marine mobile network device 100 applies the electricity generated by the solar panels and stores the electricity in the power storage module 30. In such case, the marine mobile network device 100 consumes a small number of electricity, and thus, quite a few of electricity can be stored in the power storage module 30.

On the other hand, the electricity collection plant 8 is on a land adjacent to the marine position for power transmission. The marine mobile network device 100 moves from the marine position for power generation to the marine position for power transmission so as to transmit the power of the power storage module 30 to the electricity collection plant 8. The marine mobile network device 100 transmits the electricity stored in the power storage module 30 to the electricity collection plant 8 by a manner of line transmission.

In addition, the processing module 60 may detect a value of electric quantity of the power storage module 30 and then may transmit the value to the remote end 9 through antenna module 50. Consequently, the remote end 9 obtains the value of electric quantity of the power storage module 30, such as a full power. So, the remote end 9 controls the marine mobile network device 100 moving from the marine position for power generation to the marine position for power transmission. When the electricity is transmitted completely, the remote end 9 controls the marine mobile network device 100 moving back to the marine position for power generation.

In conclusion, by means of arranging the first, second and third sub-accommodating spaces and adjusting the center of gravity through the pumping unit to change the marine positions of the marine mobile network device, a marine mobile network device and a marine self-powered generating system thereof of the present disclosure are capable of efficiently increasing the electricity. In addition, under the circumstance of self-sufficiency, the electricity can be further stored. The driving module is applied to be used in different marine positions of the marine mobile network device and the need for the configuration of the driving components is therefore reduced.

While the means of specific embodiments in present disclosure has been described by reference drawings, numerous modifications and variations could be made thereto by those skilled in the art without departing from the scope and spirit of the disclosure set forth in the claims. The modifications and variations should in a range limited by the specification of the present disclosure.

What is claimed is:

1. A marine mobile network device, feasible to be applied on the sea, comprising:
a transparent body, which is a hollow columnar structure and comprising:
a main accommodating space of which a transverse section is a regular polygonal structure or a star structure and has a plurality of planes;
a plurality of sub-accommodating spaces disposed oppositely in pairs on the transparent body, wherein two sub-accommodating spaces which are opposite to each other are adjacent to one end of the transparent body and the other two sub-accommodating spaces which are opposite to each other are adjacent to the other end of the transparent body;
a pumping unit connected to a fluid channel, the fluid channel connected to each of the plurality of sub-accommodating spaces, and the pumping unit facilitating fluids flowing to the other two sub-accommodating spaces which are opposite to each other or to the plurality of sub-accommodating spaces which are at one same side of the transparent body;
a power storage module disposed to store and supply electricity;
a driving module disposed at the other end of the transparent body and to drive the transparent body to move;
an antenna module disposed on the transparent body and to receive a movement signal or a transferred signal transmitted from a remote end, and
a processing module disposed to electrically connect to the antenna module and controlling the driving module to operate according to the movement signal or controlling the pumping unit to operate according to the transferred signal.

2. The marine mobile network device of claim 1, further comprising a plurality of solar panels electrically connected to the power storage module and respectively disposed on each of the planes, so as to receive light to generate electricity and store the electricity in the power storage module.

3. The marine mobile network device of claim 2, wherein the transparent body is made of fiberglass reinforced plastic or similar materials.

4. The marine mobile network device of claim 2, further comprising a positioning module disposed to generate a position signal according to a current position of the transparent body, and the position signal transmitted to the remote end by the antenna module.

5. The marine mobile network device of claim 4, wherein the remote end transmits the transferred signal to the marine mobile network device according to the position signal.

6. The marine mobile network device of claim 2, further comprising at least one guide vane disposed at the one side of the transparent body.

7. The marine mobile network device of claim 2, wherein the driving module comprises a driving unit, two connecting rods and a propeller; the two connecting rods are pivotally connected with each other, the driving unit is connected to one end of one of the connecting rods, and the propeller is connected to one end of the other connecting rod.

8. The marine mobile network device of claim 2, wherein when fluids flow to the plurality of sub-accommodating spaces which are at the one same side of the transparent body, the transparent body lies on the sea, and when fluids flow to the other two sub-accommodating spaces which are opposite to each other, the transparent body stands on the sea from lying on the sea gradually.

9. The marine mobile network device of claim 8, wherein an amount of fluids flowing to the other two sub-accommodating spaces which are opposite to each other is adjusted to change a center of gravity of the transparent body so as to adjust an angle of the transparent body standing on the sea.

10. The marine mobile network device of claim 2, wherein fluids are adjusted to flow to the one same side or the other same side of the transparent body, such that the transparent body has a rotational movement.

11. The marine mobile network device of claim 2, wherein the transverse section of the main accommodating space is a regular polygonal structure of a pentagonal, a hexagonal, a heptagonal or an octagonal structure.

12. The marine mobile network device of claim 2, further comprising a temperature detection module, an air flow driving module and a gas channel, the air flow driving module connected to the gas channel, one end of the gas channel disposed at the other side of the transparent body and the other end of the gas channel connected to the other end of the transparent body, and the air flow driving module disposed to inhale gas by one end of the gas channel and to exhale gas by the other end of the gas channel; the temperature detection module disposed in the transparent body to detect a temperature of the transparent body, and when a temperature of the transparent body exceeds in a predetermined temperature, the air flow driving module driven to operate by the temperature detection module.

13. A marine self-powered generating system, comprising:
a plurality of marine mobile network devices disposed on a marine position for power generation, and each of the marine mobile network devices comprising:
a transparent body which is a hollow columnar structure, comprising:
a main accommodating space of which a transverse section is a regular polygonal structure or a star structure and having a plurality of planes;
a plurality of sub-accommodating spaces disposed oppositely in pairs on the transparent body, wherein two sub-accommodating spaces which are opposite to each other are adjacent to one end of the transparent body and the other two sub-accommodating spaces which are opposite to each other are adjacent to the other end of the transparent body;
a pumping unit connected to a fluid channel, the fluid channel connected to each of the plurality of sub-accommodating spaces, and the pumping unit facilitating fluids flowing to the other two sub-accommodating spaces which are opposite to each other or to the plurality of sub-accommodating spaces which are at one same side of the transparent body;
a power storage module disposed to store and supply electricity;
a driving module disposed at the other end of the transparent body and to drive the transparent body to move;
an antenna module disposed on the transparent body and to receive a movement signal or a transferred signal transmitted from a remote end;
a processing module disposed to electrically connect to the antenna module and controlling the driving module to operate according to the movement signal or controlling the pumping unit to operate according to the transferred signal,
a plurality of solar panels electrically connected to the power storage module and respectively disposed on each of the planes, so as to receive light to generate electricity and store the electricity in the power storage module, and
an electricity collection plant on a land adjacent to the marine position for power transmission, the marine mobile network device moving from the marine position for power generation to the marine position for power transmission so as to transmit the power of the power storage module to the electricity collection plant.

14. The marine self-powered generating system of claim 13, wherein the transparent body is made of fiberglass reinforced plastic or similar materials.

15. The marine self-powered generating system of claim 13, further comprising a positioning module disposed to produce a position signal according to a current position of the transparent body, and the position signal transmitted to the remote end by the antenna module, wherein the remote end transmits the transferred signal to the marine mobile network device according to the position signal.

16. The marine self-powered generating system of claim 13, further comprising at least one guide vane disposed at the one side of the transparent body.

17. The marine self-powered generating system of claim 13, wherein the driving module comprises a driving unit, two connecting rods and a propeller; the two connecting rods are pivotally connected with each other, the driving unit is connected to one end of one of the connecting rods, and the propeller is connected to the one end of the other connecting rod.

18. The marine self-powered generating system of claim 13 wherein when fluids flow to the plurality of sub-accommodating spaces which are at the one same side of the transparent body, the transparent body lies on the sea, and when fluids flow to the other two sub-accommodating spaces which are opposite to each other, the transparent body stands on the sea from lying on the sea gradually.

19. The marine self-powered generating system of claim 18, wherein an amount of fluids flowing to the other pair of sub-accommodating spaces which is opposite to each other is adjusted to adjust a center of gravity of the transparent body so as to adjust an angle of the transparent body standing on the sea with an angle from 30° to 60°.

20. The marine self-powered generating system of claim 13, wherein fluids are adjusted to flow to the same side or the other same side of the transparent body, such that the transparent body has a rotational movement.

21. The marine self-powered generating system of claim 13, wherein the transverse section of the main accommodating space is a regular polygonal structure of a pentagonal, a hexagonal, a heptagonal or an octagonal structure.

22. The marine self-powered generating system of claim 13, further comprising a temperature detection module, an air flow driving module and a gas channel, the air flow driving module connected to the gas channel, one end of the gas channel disposed at the other side of the transparent body and the other end of the gas channel connected to the other end of the transparent body, and the air flow driving module disposed to inhale gas by one end of the gas channel and to exhale gas by the other end of the gas channel; the temperature detection module disposed in the transparent body to detect a temperature of the transparent body, and when a temperature of the transparent body exceeds in a predetermined temperature, the air flow driving module driven to operate by the temperature detection module.
